(19) United States
(12) Patent Application Publication
(10) Pub. No.: US 2013/0057411 A1
(43) Pub. Date: Mar. 7, 2013

(54) METHODS AND APPARATUSES FOR SYNCHRONIZATION OF DOWNHOLE TOOL WITH REMOTE TRANSMITTERS AND SENSORS

(71) Applicants: Samuel R. Bell, Tomball, TX (US); Paul G. Cairns, Houston, TX (US); John A. Signorelli, Cypress, TX (US)

(72) Inventors: Samuel R. Bell, Tomball, TX (US); Paul G. Cairns, Houston, TX (US); John A. Signorelli, Cypress, TX (US)

(73) Assignee: BAKER HUGHES INCORPORATED, Houston, TX (US)

(21) Appl. No.: 13/407,175

(22) Filed: Feb. 28, 2012

Related U.S. Application Data
(60) Provisional application No. 61/448,045, filed on Mar. 1, 2011.

(51) Int. Cl. G01V 3/00

(52) U.S. Cl. 340/853.3

(57) ABSTRACT

The present disclosure includes an apparatus and method for operating a downhole tool in a borehole. The apparatus may include a downhole tool that may include at least one second clock, which may be synchronized to a first clock by way of a modulator/demodulator device. The downhole tool may be configured to estimate a parameter of interest of an underground feature. The underground feature may relate to one or more of: a borehole, a casing, or an earth formation. The downhole tool may comprise two or more sections that are configured to operate synchronously when the one or more second clocks are synchronized with the first clock. The modulator/demodulator may include a modem associated with the first clock, a modem associated with the at least one second clock, and a low frequency conductor between the two modems. The method includes using the apparatus.

### CROSS-REFERENCE TO RELATED APPLICATION

This application claims priority from U.S. Provisional Patent Application Ser. No. 61/448,045, filed on 1 Mar. 2011, the disclosure of which is incorporated herein by reference in its entirety.

### BACKGROUND OF THE DISCLOSURE

1. Field of the Disclosure

In one aspect, this disclosure generally relates methods and apparatuses for downhole tools, more specifically, for operating downhole tools by synchronizing clocks in tool subsystems.

2. Background of the Art

Downhole tools may be used to determine parameters of earth formations and the boreholes that may penetrate the earth formations. For example, electromagnetic induction resistivity instruments can be used to determine the electrical conductivity of earth formations surrounding a borehole. An electromagnetic induction well logging instrument may include a transmitter coil and a plurality of receiver coils positioned at axially spaced apart locations along the instrument housing. An alternating current may then be passed through the transmitter coil. Voltages which are induced in the receiver coils as a result of alternating magnetic fields induced in the earth formations are then measured. The magnitude of certain phase and amplitude components of the induced receiver voltages are related to the conductivity of the media surrounding the instrument.

Multiple downhole tools may be positioned along a carrier, such as a drill string or a wireline, and an individual downhole tool may be divided into two or more subsections. Subsections of a particular tool may be located adjacent to one another or separated by an intervening object, such as an unrelated subsystem, a length of pipe, a spacer, collar section, etc.

### SUMMARY OF THE DISCLOSURE

In aspects, the present disclosure is related to an apparatus and method for downhole tool operation in a borehole. More specifically, the present disclosure relates to operating a downhole tool configured to estimate parameters of a borehole or the earth formation that is penetrated by the borehole that has two or more clocks which may be synchronized through a modulator-demodulator device.

One embodiment according to the present disclosure includes a method for operating a downhole tool in a borehole in an earth formation, comprising: operating the downhole tool in the borehole by at least synchronizing a first clock with a second clock in the downhole tool, wherein the first and second clocks communicate through a modulator/demodulator device.

Another embodiment according to the present disclosure includes an apparatus for operation in a borehole in an earth formation, comprising: a carrier configured to be conveyed in a borehole; a first clock at a first frequency; and a downhole tool disposed on the carrier, the downhole tool comprising: a second clock at a second frequency, and a modulator-demodulator device configured to allow the second clock to be synchronized with the first clock.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of a drilling rig with a downhole tool according to one embodiment of the present disclosure;

FIG. 2 shows a schematic of a downhole tool according to one embodiment of the present disclosure;

FIG. 3 shows a flow chart of a method of synchronizing two clocks in a downhole tool according to one embodiment of the present disclosure; and

FIG. 4 shows a data flow chart of a method of synchronizing two clocks in a downhole tool according to one embodiment of the present disclosure.

### DETAILED DESCRIPTION OF THE DISCLOSURE

The present disclosure relates to apparatuses and methods for operating a downhole tool in a borehole. More specifically, the present disclosure relates to operating a downhole tool configured to estimate at least one parameter of interest of a subsurface feature using at least two clocks which may be synchronized through a modulator-demodulator device. The present disclosure is susceptible to embodiments of different forms. There are shown in the drawings, and herein will be described in detail, specific embodiments of the present disclosure with the understanding that the present disclosure is to be considered an exemplification of the principles of the present disclosure and is not intended to limit the present disclosure to that illustrated and described herein.

In some aspects, the present disclosure may include a downhole tool configured to acquire information about a subsurface feature that may include at least one of: (i) a resistivity measurement, (ii) an acoustic measurement, and (iii) a nuclear measurement. Herein, the term “subsurface feature” may relate to one or more of: (i) downhole equipment, (ii) drilling fluid, (iii) borehole casing, (iv) an earth formation, and (v) a borehole. In other aspects, the present disclosure may include a downhole tool configured to acquire information about the borehole that may include at least one of: (i) borehole geometry, (ii) borehole inclination, (iii) borehole azimuth, (iv) borehole diameter, (v) borehole ovality, and (vi) borehole trajectory. Herein, the term “information” may relate to one or more of: (i) raw data, (ii) processed data, and (iii) signals.

Downhole conditions, such as heat and pressure, may cause a clock to drift in terms of phase or frequency. When one or more clocks drift, the lack of agreement between the clocks may result in a loss or corruption of information. Herein, the term “clock” refers to devices that keep time and/or provide a time signal to other devices. Clock drift may render information unusable. The present disclosure includes methods and apparatuses for synchronizing two clocks that are separated by a modulator-demodulator device such that a high frequency signal (a clocking signal) may be transmitted from a first clock to a second clock without requiring a dedicated communication line designed to carry high frequency signals. Dedicated communication lines may require closer proximity of the clocks (less than 5 meters) or special types of wiring (coaxial cables, twisted pairs, etc.). In circumstances where the clocks may be separated by an intervening object, such as a section of pipe or another tool, the use of a dedicated line may be impractical or impossible.

Benefits of the proposed technique may include the use of a low frequency communication line between clocks located downhole that require synchronization and longer distances between downhole clocks while maintaining synchronized operation. One non-limiting embodiment of an apparatus configured to use the proposed technique is described below.

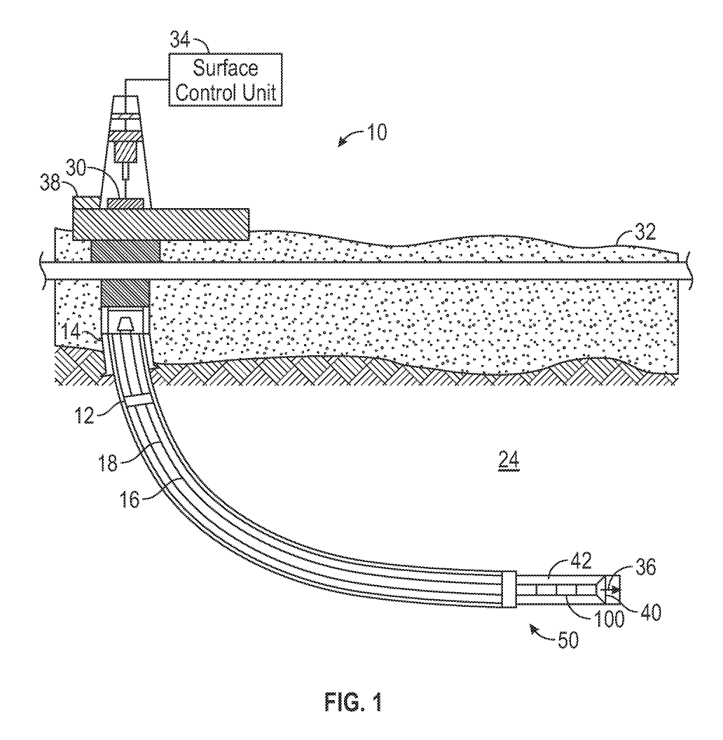

FIG. 1 shows a schematic diagram of a drilling system 10 according to one embodiment of the present disclosure. FIG. 1 shows a borehole 12 in an earth formation 24 that includes a casing 14 with a carrier 16. The term “carrier” as used herein means any device, device component, combination of devices, media and/or member that may be used to convey, house, support, or otherwise facilitate the use of another device, device component, combination of devices, media and/or member. Exemplary non-limiting carriers include drill strings of the coiled tube type, of the jointed pipe type, and any combination or portion thereof. Other carrier examples include casing pipes, wirelines, wireline sondes, slickline sondes, drop shots, downhole subs, bottom hole assemblies (BHAs), drill string inserts, modules, internal housings, and substrate portions thereof.

The drill string 16 may include a tubular member 18 that carries a BHA 50 at a distal end. The tubular member 18 may be made up by joining drill pipe sections. The drill string 16 extends to a rig 30 at the surface 32. The drill string 16, which may be jointed tubulars or coiled tubing, may include power and/or data conductors such as wires for providing bidirectional communication and power transmission. A top drive (not shown), or other suitable rotary power source, may be utilized to rotate the drill string 16. A controller 34 may be placed at the surface 32 for receiving and processing downhole data. The controller 34 may include a processor, a storage device for storing data and computer programs. The processor may access the data and programs from the storage device and executes the instructions contained in the programs to control the drilling operations. During drilling operations, a suitable drilling fluid 36 is circulated under pressure through a bore in the drill string 16 by a mud pump 38. The drilling fluid 36 is discharged at the borehole bottom through an opening in the drill bit 40. The drilling fluid 36 circulates uphole through the annular space 42 between the drill string 16 and a wall of the borehole 12. The BHA 50 may include a downhole tool 100.

Downhole tool 100 may be configured to acquire information related to the borehole 12, the earth formation, or both. Downhole tool 100 may be configured to perform one or more operations within the borehole 12 including, but not limited to, adjusting stabilizers, extending extensible arms, and geosteering. Downhole tool 100 may includes a downhole controller, which may include a controller, a data storage medium, such as a solid state memory, and associated electronic circuitry for processing the measurements taken by the tool. Downhole tool 100 may include a circuit configured with one or more clocks.

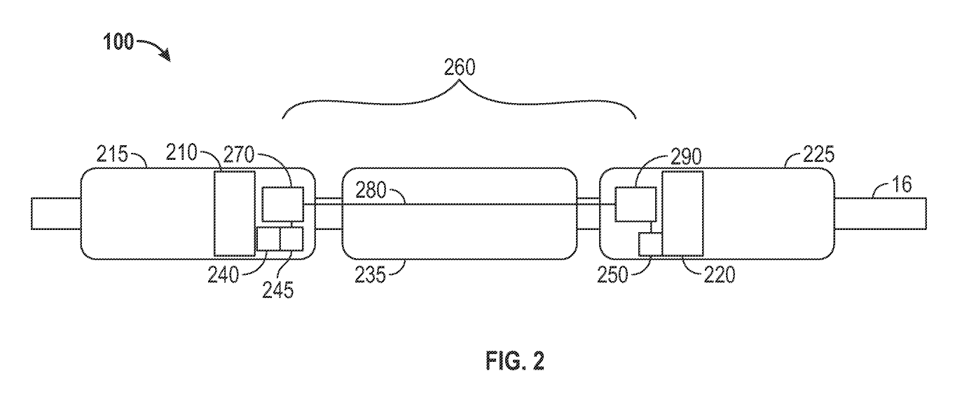

FIG. 2 shows an exemplary schematic of tool 100. In some embodiments (shown here), the tool 100 may be configured for resistivity measurements may include a transmitter 210 and at least one receiver 220 disposed along drill string 16. The tool 100 may be divided into two or more subs, such that a first sub 215 includes transmitter 210 and the second sub 225 includes receiver 220. The transmitter 210 may need to be synchronized with the at least one receiver 220 despite being separated by an intervening piece of equipment 235.

To synchronize the transmitter 210 and the at least one receiver 220, a clock 240 on first sub 215 may be associated with transmitter 210 and another clock 250 on second sub 225 may be associated with at least one receiver 220. Sub 215 may include at least one controller 245 configured to generate a reference signal using an output from clock 240. The at least one controller 245 may include at least one processor (not shown). Herein, a processor may relate to any integrated circuit computing device, including, but not limited to, (i) a microprocessor, (ii) a field-programmable gate array (FPGA), (iii) an application specific integrated circuit (ASIC), (iv) a reduced instruction set computer (RISC), (v) a programmable logic array (PAL), and (vi) a Bit Slice processor. The controller 245 may also include a computer storage medium configured to store instructions that may be executed by the at least one processor of controller 245. The computer storage medium may include any non-transitory machine-readable storage medium known to those of skill in the art, including but not limited to one or more of: (i) a ROM, (ii) an EPROM, (iii) an EEPROM, (iv) a flash memory, and (v) an optical disk. In some embodiments, the output from clock 240 may serve as the reference signal without the use of controller 245. The reference signal may be configured to cause another clock 250 to be synchronized with the first clock 240 in terms of frequency and/or phase.

Clock 250 may be synchronized with clock 240 across a modulator/demodulator device 260. The modulator/demodulator 260 may be configured to modulate and demodulate a high frequency signal using any appropriate modulation/demodulation techniques known to one of skill in the art. Modulation/demodulation techniques that may be used in modulator/demodulator 260 may include, but are not limited to, one of: (i) frequency-shift keying (FSK), (ii) amplitude-shift keying (ASK), (iii) phase-shift keying (PSK), (iv) continuous-phase frequency-shift keying (CPFSK), (v) orthogonal frequency division multiplexing (OFDM), (vi) amplitude modulation (AM), (vii) frequency modulation (FM), (viii) quadrature amplitude modulation (QAM), and (ix) minimum-shift keying (MSK). The modulator/demodulator device 260 may include a modem 270 associated with clock 240 and configured to modulate and transmit a reference signal across a low frequency conductor 280 to a modem 290 associated with clock 250. Modem 290 may be configured to demodulate the reference signal and communicate the signal to clock 250.

In some embodiments, the reference signal may be used to generate a synchronization signal, such as through a phase lock loop circuit, which may be used to synchronize clock 250. The synchronization signal may be related to the reference signal such that the synchronization signal has at least one of: (i) the identical frequency as the reference signal, (ii) the reference signal frequency multiplied by an integer, (iii) the reference signal frequency divided by an integer, (iv) the phase of the reference signal, and (v) the phase of the reference signal plus an offset. In some embodiments, the synchronization may be performed from clock 250 to clock 240. In other embodiments, the reference signal may be sent to a plurality of clocks. In some embodiments, there may be a plurality of transmitters that are controlled by one or more clocks. Likewise, there may be a plurality of receivers that are controlled by one or more clocks. Generally, low frequency conductor 280 may be capable of communicating low frequency signals but not high frequency signals (10 MHz and above). In some embodiments, low frequency conductor 280 may be part of a non-communication circuit, such as a power line. In some embodiments, low frequency conductor 280 may be part of a communication system configured to convey communications with several tools along the carrier.

In some embodiments, the synchronization signal may be an output from demodulator 290. In another embodiment, the synchronization signal may be an output from at least one processor (not shown) that may receive the demodulated signal and that does not use instructions from an associated computer storage medium. In still other embodiments, the synchronization signal may be an output from at least one processor (not shown) that may receive the demodulated signal and that does use instructions from an associated computer storage medium.

In some embodiments, the downhole tool 100 may be configured to initiate an operation (such as an acquisition of information) based on a difference between a signal from the first clock 240 and a signal from the second clock 250. This difference may be related to one more of: (i) phase, (ii) amplitude, and (iii) frequency. For example, transmitter 210 may be triggered to begin a measurement operation when the phase difference between the clocks 240, 250 is within 1 degree. The phase difference for triggering an operation may be a user selected range. The phase difference may also be an offset, such that, for example, the operation may be triggered when the phase difference between the clocks 240, 250 is within 1 degree of a 40 degree phase difference (39-41 degrees).

In some embodiments, the first sub 215 and the second sub 225 may be adjacent or combined in the same housing without an intervening piece of equipment 235 between the first sub 215 and the second sub 225. The intervening equipment 235 may include sensors, devices, a spacer, etc. that separates the first section 215 from the second section 225. The transmitter 210 may be configured to impart a transient electromagnetic signal into an earth formation. The at least one receiver coil 220 may be configured to receive a transient electromagnetic signal from the earth formation and convert the received signal into an output signal.

In another embodiment, the tool 100 may be configured to perform nuclear measurement. The transmitter 210 may be configured to impart a neutron or gamma signal into the earth formation, such as through the use of a chemical nuclear source or a pulsed neutron source. The at least one receiver 210 may include at least one radiation detector. Similarly, in another embodiment, the tool 100 may be configured to perform acoustic measurements, where the transmitter 210 may be configured to impart an acoustic signal and receiver 220 may be configured to generate a signal in response to a received acoustic signal. In other embodiments, tool 100 may include other devices. Such devices may include, but are not limited to, one or more of: (i) an inclinometer, (ii) a gravimeter, (iii) an accelerometer, (iv) a magnetometer, and (v) a gyroscope. In still other embodiments, the first clock 215 and its associated modem 270 may be located outside the downhole tool 100, such as at the surface, and the low frequency conductor 280 may extend from modem 270 to modem 290 in downhole tool 100.

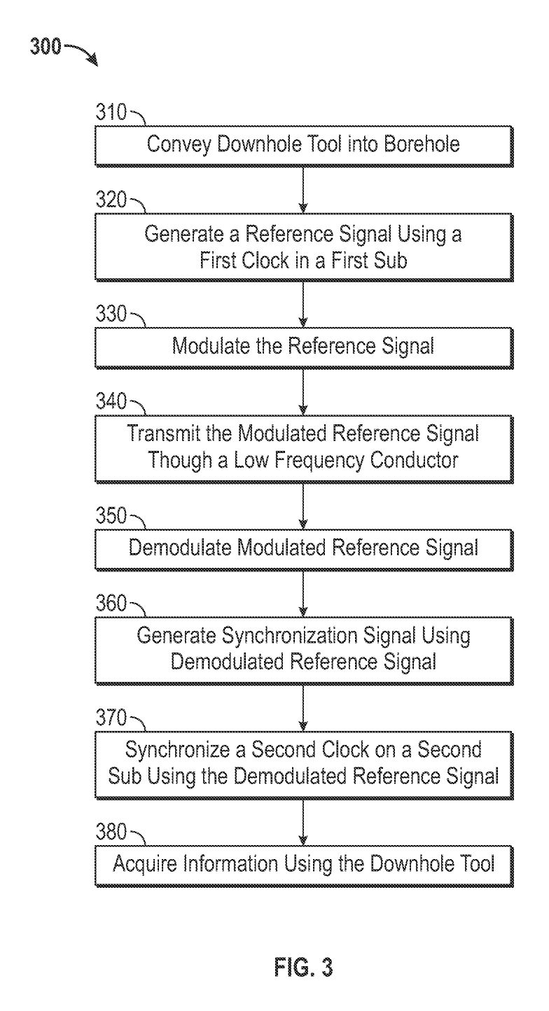

FIG. 3 shows of flow chart of a method 300 according to one embodiment of the present disclosure. In step 310, a downhole tool 100 is conveyed into a borehole 12 in an earth formation 24. In step 320, a reference signal may be generated using the first clock 240. In step 330, the reference signal may be modulated by a first modem 270. In step 340, the modulated reference signal may be transmitted along a low frequency conductor 280 configured to connect modem 270 and modem 290. In step 350, the modulated reference signal may be demodulated by modem 290. In step 360, the demodulated reference signal may be converted to a synchronization signal. In step 370, second clock 250 may be synchronized with clock 240 via the synchronization signal. In some embodiments, step 360 may be optional and step 370 may directly use the demodulated reference signal to synchronize the second clock 250 with the first clock 240. Synchronization of the clock 250 may include matching clock 250 to clock 240 in terms of one or more of: (i) a first clock frequency, (ii) an integral multiple of the first clock frequency, (iii) an integral division of the first clock frequency, (iv) phase, and (v) a phase with a selected offset. In step 380, information may be acquired by the second sub 225 of the downhole tool 110.

Some embodiments may include a step of initiating an operation (such as information acquisition) based on a difference between a signal from the first clock 240 and a signal from the second clock 250. This difference may be related to one more of: (i) phase, (ii) amplitude, and (iii) frequency. For example, in this step, transmitter 210 may be triggered to begin a measurement operation when the phase difference between the clocks 240, 250 is within 1 degree. The phase difference for triggering an operation may be a user selected range. The phase difference may also be an offset, such that, for example, the operation may be triggered when the phase difference between the clocks 240, 250 is within 1 degree of a 40 degree phase difference (39-41 degrees).

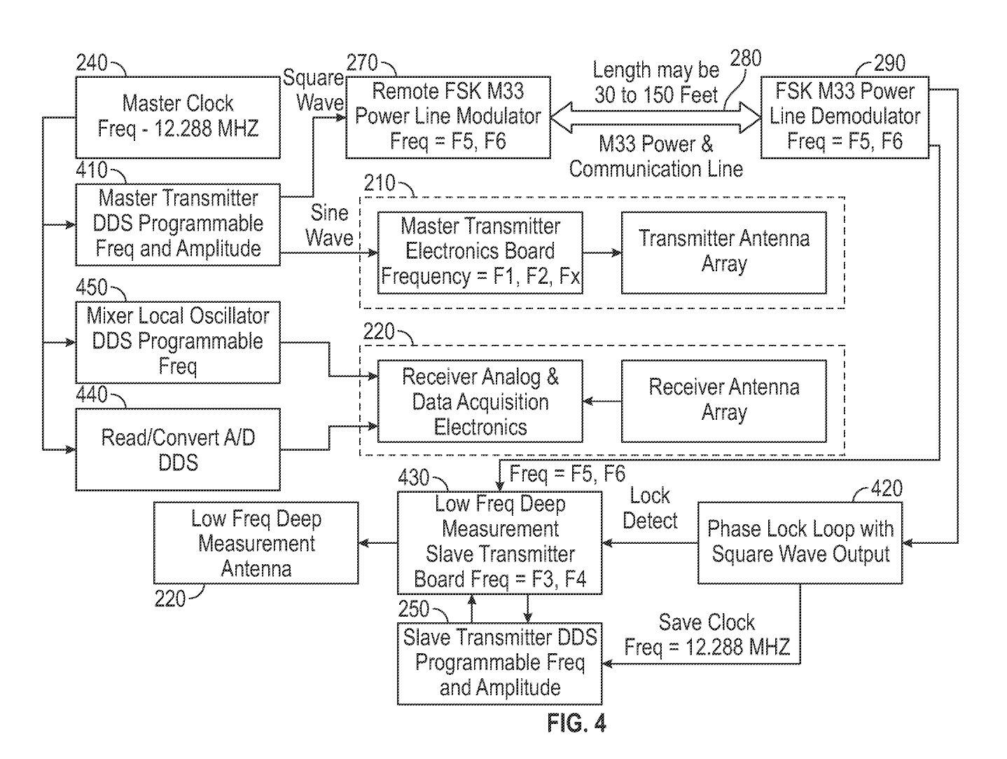

FIG. 4 shows a data flow chart for method 300. The first clock 240 may provide a clocking signal to a master transmitter direct digital synthesizer (DDS) 410 which may be associated with transmitter 210. The first clock 240 may also provide a clocking signal to a converter 440 and oscillator 450 associated with receiver 220. The master transmitter DDS 410 may transmit a square wave reference signal to modem 270. The master transmitter DDS 410 may also generate a signal for transmitter 210. The reference signal may be a binary division of the frequency of first clock 240. Modem 270 may modulate the reference signal and transmit the modulated signal along conductor 280. One exemplary modem that may serve as modem 270 is a remote FSK M33 powerline modulator.

The modulated signal may be demodulated by modem 290 and transmitted to a phase loop lock circuit 420. One exemplary modem that may serve as modem 290 is a remote FSK M33 powerline modulator. The phase loop lock circuit 420 may be configured to lock onto the demodulated square wave signal and to produce a clock signal for synchronizing the second clock 250. The phase loop lock circuit 420 may be configured to generate a phase lock detection signal. The phase lock detection signal may be used to confirm the receipt of a valid reference signal and/or as an activation signal for transmitter driver 430. Upon receipt of the phase lock detection signal, the activation of transmitter driver 430 may be instantaneous or time delayed.

While the disclosure has been described with reference to exemplary embodiments, it will be understood that various changes may be made and equivalents may be substituted for elements thereof without departing from the scope of the disclosure. In addition, many modifications will be appreciated to adapt a particular instrument, situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

While the foregoing disclosure is directed to the one mode embodiments of the disclosure, various modifications will be apparent to those skilled in the art. It is intended that all variations within the scope of the appended claims be embraced by the foregoing disclosure.

We claim:

1. A method for operating a downhole tool in a borehole in an earth formation, comprising:
operating the downhole tool in the borehole by at least synchronizing a first clock with a second clock in the downhole tool, wherein the first and second clocks communicate through a modulator/demodulator device.

2. The method of claim 1, wherein the first clock is in the downhole tool.

3. The method of claim 1, further comprising:
acquiring information using the downhole tool.

4. The method of claim 3, wherein the information relates to at least one of: (i) a resistivity measurement, (ii) an acoustic measurement, and (iii) a nuclear measurement.

5. The method of claim 3, wherein the information relates to a subsurface feature.

6. The method of claim 5, wherein the subsurface feature includes at least one of: (i) downhole equipment, (ii) drilling fluid, (iii) borehole casing, (iv) the earth formation, and (v) the borehole.

7. The method of claim 3, wherein the information relates to at least one of: (i) borehole geometry, (ii) borehole inclination, (iii) borehole azimuth, (iv) borehole diameter, (v) borehole ovality, and (vi) borehole trajectory.

8. The method of claim 1, further comprising:
initiating information acquisition using a difference between the first clock and the second clock, wherein the difference is in at least one of: (i) phase, (ii) amplitude, and (iii) frequency.

9. The method of claim 8, wherein the information acquisition is initiated when the difference is within a selected range.

10. The method of claim 1, wherein the first clock is associated with at least one transmitter and the second clock is associated with at least one receiver.

11. The method of claim 1, wherein the second frequency is equal to one of: (i) the first frequency, (ii) the first frequency multiplied by an integer, and (iii) the first frequency divided by an integer.

12. An apparatus for operation in a borehole in an earth formation, comprising:
a carrier configured to be conveyed in a borehole;
a first clock at a first frequency; and
a downhole tool disposed on the carrier, the downhole tool comprising:
a second clock at a second frequency, and
a modulator-demodulator device configured to allow the second clock to be synchronized with the first clock.

13. The apparatus of claim 12, wherein the downhole tool further comprises the first clock.

14. The apparatus of claim 12, wherein the downhole tool is configured to acquire information.

15. The apparatus of claim 14, wherein the information relates to at least one of: (i) a resistivity measurement, (ii) an acoustic measurement, and (iii) a nuclear measurement.

16. The apparatus of claim 14, wherein the information relates to a subsurface feature.

17. The apparatus of claim 16, wherein the subsurface feature includes at least one of: (i) downhole equipment, (ii) drilling fluid, (iii) borehole casing, (iv) the earth formation, and (v) the borehole.

18. The apparatus of claim 14, wherein the information relates to at least one of: (i) borehole geometry, (ii) borehole inclination, (iii) borehole azimuth, (iv) borehole diameter, (v) borehole ovality, and (vi) borehole trajectory.

19. The apparatus of claim 12, further comprising:
at least one processor configured to synchronize the second clock with the first clock.

20. The apparatus of claim 19, further comprising:
a non-transitory computer storage medium including instructions for synchronizing the second clock with the first clock, wherein the at least one processor is further configured to execute the instructions.

21. The apparatus of claim 19, wherein the non-transitory computer storage medium further includes instructions that, when executed, cause the at least one processor to initiate information acquisition using a difference in a a signal of the first clock and a signal of the second clock, wherein the difference is in at least one of: (i) phase, (ii) amplitude, and (iii) frequency.

22. The method of claim 21, wherein the difference is within a selected range.

23. The apparatus of claim 12, wherein the first clock is associated with at least one transmitter and the second clock is associated with at least one receiver.

24. The apparatus of claim 12, wherein the second frequency is equal to one of: (i) the first frequency, (ii) the first frequency multiplied by an integer, and (iii) the first frequency divided by an integer.
